(19) United States
(12) Patent Application Publication
(10) Pub. No.: US 2025/0300329 A1
(43) Pub. Date: Sep. 25, 2025

(54) RECHARGEABLE BATTERY

(71) Applicant: SAMSUNG SDI CO., LTD., Yongin-si (KR)

(72) Inventor: Dae Kyu KIM, Yongin-si (KR)

(21) Appl. No.: 18/792,437

(22) Filed: Aug. 1, 2024

(30) Foreign Application Priority Data
Mar. 25, 2024 (KR) 10-2024-0040608

(51) Int. Cl. H01M 50/536; H01M 10/04; H01M 50/107; H01M 50/152

(52) U.S. Cl. CPC H01M 50/536; H01M 10/0422; H01M 10/0431; H01M 50/107; H01M 50/152

(57) ABSTRACT

A rechargeable battery includes: an electrode assembly having an uncoated region; a can having a bottom portion facing the uncoated region and a side portion connected to an edge of the bottom portion, the can accommodating the electrode assembly in an inner space thereof, the bottom portion of the can having a base part connected to the side portion and a plurality of welding stepped parts protruding from the base part toward the uncoated region and welded to the uncoated region; and a cap plate coupled to an open end of the side portion to seal the can.

### CROSS-REFERENCE TO RELATED APPLICATION

The present application claims priority to and the benefit of Korean Patent Application No. 10-2024-0040608, filed on Mar. 25, 2024, in the Korean Intellectual Property Office, the entire disclosure of which is incorporated herein by reference.

### BACKGROUND

### 1. Field

Aspects of embodiments of the present disclosure relate to a rechargeable battery.

### 2. Description of the Related Art

Rechargeable batteries are used for various purposes, from powering small electronic devices, such as mobile phones and laptop computers, to powering motors for transportation vehicles, such as electric vehicles and hybrid vehicles.

Rechargeable batteries may be classified as cylindrical, prismatic, and pouch-type depending on their appearance.

A cylindrical rechargeable battery may include an electrode assembly wound in the form of a jelly roll, a can that accommodates the electrode assembly and an electrolyte solution in an internal space, and a cap plate that is coupled to an open end of the can to seal the can. The electrode assembly can be physically and electrically connected to a member that acts as an outer terminal via a current collecting plate.

### SUMMARY

Embodiments of the present disclosure provide a rechargeable battery that may reduce the number of parts by omitting the current collecting plate, may simplify the internal configuration and the manufacturing process, and may increase the capacity.

A rechargeable battery, according to an embodiment of the present disclosure, includes an electrode assembly, a can, and a cap plate. The electrode assembly has an uncoated region. The can has a bottom portion facing the uncoated region and a side portion connected to an edge of the bottom portion. The can accommodates the electrode assembly in an inner space thereof. The cap plate is coupled to an open end of the side portion to seal the can. The bottom portion has a base part connected to the side portion and a plurality of welding stepped parts protruding from the base part toward the uncoated region and welded to the uncoated region.

A thickness of the bottom portion may be smaller than a thickness of the side portion. The bottom portion may have a constant thickness, and the thickness of the bottom portion may be equal to or greater than 0.6 times and less than 1 times the thickness of the side portion.

The side portion and the base part may be connected by a curved portion. A height difference between the base part and each of the plurality of welding stepped parts may be equal to or greater than the thickness of the bottom portion. Each of the plurality of welding stepped parts may be in contact with the curved portion, and the curved portion may have a U-shaped cross-section in a region adjacent to the plurality of welding stepped parts.

The plurality of welding stepped parts may have the same shape, size, and protruding height and may be positioned at a distance from each other along a circumferential direction of the bottom portion. Each of the plurality of welding stepped parts may have a rectangular bar shape, and the plurality of welding stepped parts may be arranged parallel to a radial direction of the bottom portion at an equal distance from a center of the bottom portion. Each of the plurality of welding stepped parts may have a circular shape, and the plurality of welding stepped parts may be arranged at an equal interval along the circumferential direction of the bottom portion.

The plurality of welding stepped parts may include welding stepped parts having at least two different shapes. The plurality of welding stepped parts may include a plurality of first stepped parts having a rectangular bar shape and a plurality of second stepped parts having a circular arc shape. The plurality of first stepped parts may be arranged parallel to the radial direction of the bottom portion at an equal distance from the center of the bottom portion. The plurality of second stepped parts may be arranged parallel to the circumferential direction of the bottom portion at a distance from the plurality of first stepped parts.

A rechargeable battery, according to another embodiment of the present disclosure, includes an electrode assembly, a can, and a cap plate. The electrode assembly has an uncoated region. The can has a bottom portion facing the uncoated region and a side portion connected to the edge of the bottom portion, and the can accommodates the electrode assembly in an inner space thereof. The cap plate is coupled to an open end of the side portion and seals the can. The bottom portion has a base part connected to the side portion, a protrusion and depression structure around a center of the base part, and a plurality of welding stepped parts protruding from the base part toward the uncoated region and welded to the uncoated region.

A thickness of the bottom portion may be smaller than a thickness of the side portion. The protrusion and depression structure may include a recess portion and a protruding portion protruding from the recess portion toward the electrode assembly. A height difference between the recess portion and the protruding portion may be greater than a height difference between the base part and each of the plurality of welding stepped parts. A lower surface of the recess portion may be lower than a lower surface of the base part and a lower end of the side portion. An upper surface of the protruding portion may be equal to or higher than an upper surface of each of the plurality of welding stepped parts.

The bottom portion may have a constant thickness, and a thickness of the bottom portion may be equal to or greater than 0.6 times and less than 1 times a thickness of the side portion. The plurality of welding stepped parts may have the same shape, size, and protruding height and may be positioned at a distance from each other along a circumferential direction of the bottom portion.

The plurality of welding stepped parts may include a plurality of first stepped parts having a rectangular bar shape and a plurality of second stepped parts having a circular arc shape. The plurality of first stepped parts may be arranged parallel to the radial direction of the bottom portion at an equal distance from the center of the bottom portion. The plurality of second stepped parts may be arranged parallel to the circumference direction of the bottom portion at a distance from the plurality of first stepped parts.

The cap plate may have a terminal hole. The rechargeable battery may further include a rivet terminal installed in the terminal hole via an insulator, and a current collecting plate inside the cap plate and connected to the rivet terminal. The uncoated region may be a first uncoated region, and the electrode assembly may have a second uncoated region. The second uncoated region may be on the opposite side of the first uncoated region and may be fixed to the current collecting plate. The cap plate may have (e.g., may be charged with) the same polarity as the can.

The rechargeable battery, according to embodiments of the present disclosure, provides increased capacity because a space previously occupied by a negative electrode current collecting plate in a conventional rechargeable battery may be replaced with a larger electrode assembly. Additionally, the rechargeable battery, according to embodiments of the present disclosure, may simplify an internal configuration and a manufacturing process by reducing the number of parts compared to conventional rechargeable batteries.

### BRIEF DESCRIPTION OF THE DRAWINGS

FIG. 1 is a perspective view of a rechargeable battery according to an embodiment.

FIG. 2 is a cross-sectional view of the rechargeable battery shown in FIG. 1.

FIG. 3 is an enlarged view of an electrode assembly of the rechargeable battery shown in FIG. 2.

FIG. 4 is a perspective view of a bottom portion of the rechargeable battery shown in FIG. 1.

FIG. 5 is a cross-sectional view of the bottom portion shown in FIG. 4.

FIG. 6 is a schematic diagram showing a movement trajectory of a laser beam for welding the bottom portion shown in FIG. 4.

FIG. 7 is a partial enlarged view of the rechargeable battery shown in FIG. 2.

FIG. 8 is a perspective view of a bottom portion of a rechargeable battery according to another embodiment.

FIG. 9 is a partial cross-sectional view of a bottom portion shown in FIG. 8.

FIG. 10 is a perspective view of a bottom portion of a rechargeable battery according to another embodiment.

FIG. 11 is a schematic diagram showing a movement trajectory of a laser beam for welding in the bottom portion shown in FIG. 10.

FIG. 12 is a perspective view of a bottom portion of a rechargeable battery according to another embodiment.

FIG. 13 is a schematic diagram showing a movement trajectory of a laser beam for welding in the bottom portion shown in FIG. 12.

FIG. 14 is a perspective view of a bottom portion of a rechargeable battery according to another embodiment.

FIG. 15 is a cross-sectional view of the bottom portion shown in FIG. 14.

### DETAILED DESCRIPTION

Hereinafter, the present disclosure will be described more fully with reference to the accompanying drawings, in which embodiments of the present disclosure are shown. As those skilled in the art would realize, the described embodiments may be modified in various different ways, all without departing from the spirit or scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

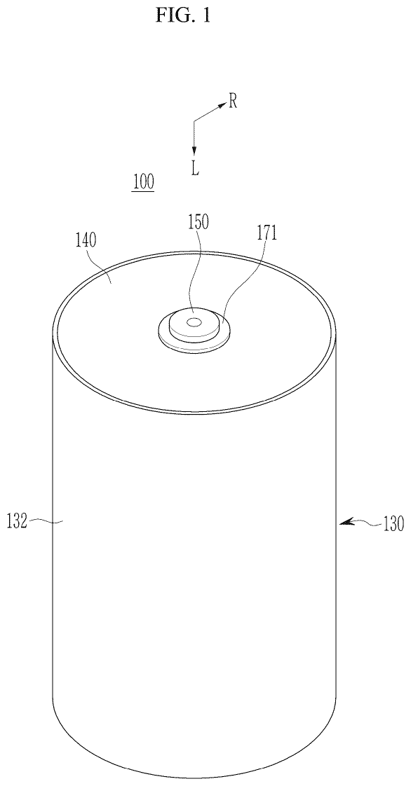

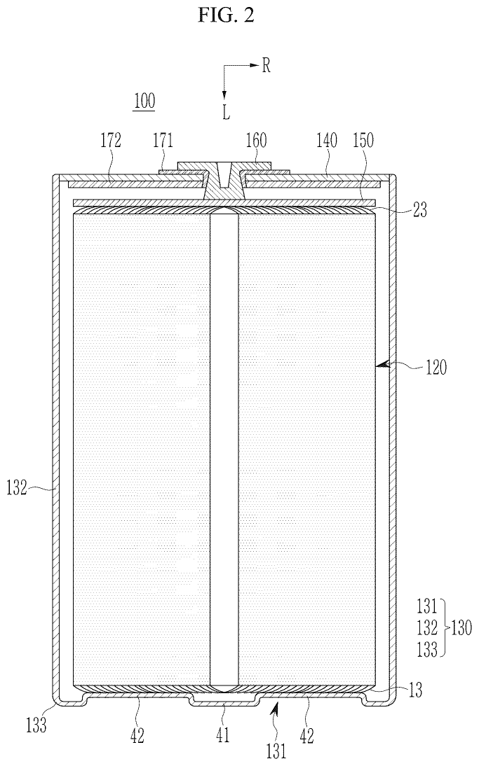

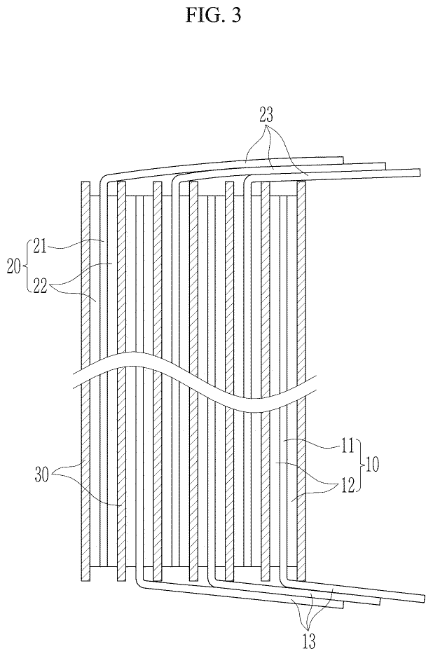

FIG. 1 is a perspective view of a rechargeable battery according to an embodiment. FIG. 2 is a cross-sectional view of the rechargeable battery shown in FIG. 1. FIG. 3 is an enlarged view of an electrode assembly of the rechargeable battery shown in FIG. 2.

Referring to FIG. 1 to FIG. 3, a rechargeable battery 100, according to an embodiment of the present embodiment, may include an electrode assembly 120, a can 130 that accommodates the electrode assembly 120 in an inner space, and a cap plate 140 that is coupled to an open end of the can 130 and seals (e.g., seals the inner space of) the can 130. The can 130 may have a bottom portion 131 and a side portion 132 having different thicknesses. The bottom portion 131 of the can 130 may have a plurality of welding stepped parts 42 and may act as a current collecting plate.

The electrode assembly 120 may include a first electrode 10, a second electrode 20, and a separator 30. The electrode assembly 120 may be a wound type electrode assembly in which a band-shaped stack is wound in a jelly roll shape. The stack may include (or may consist of) the sequentially stacked first electrode 10, separator 30, second electrode 20, and separator 30, and may be wound multiple times around a center pin. In the stack, the positions of the first electrode 10 and the second electrode 20 may be switched.

The first electrode 10 may include a first substrate 11 and a first composite layer 12 on the first substrate 11. The first composite layer 12 may be on a portion (e.g., a remaining portion) of the first substrate 11 except for one (e.g., lower) edge thereof. From among the first substrate 11, the portions of the first substrate 11 that is exposed without being covered with the first composite layer 12 may be referred to as a first uncoated region 13.

The second electrode 20 may include a second substrate 21 and a second composite layer 22 on the second substrate 21. The second composite layer 22 may be positioned on a portion (e.g., a remaining portion) of the second substrate 21 except for another (e.g., upper) edge. From among the second substrate 21, the portion of the second substrate 21 where the surface is exposed and not covered with the second composite layer 22 may be referred to as a second uncoated region 23.

In a lithium ion rechargeable battery, the first substrate 11 may be a copper foil or a nickel foil, and the first composite layer 12 may include graphite, a conductive material, and a binder. The second substrate 21 may be an aluminum foil, and the second composite layer 22 may include a transition metal oxide, such as LiCoO₂, LiNiO₂, LiMn₂O₄, Li(NiCoAl)O₂, LiFePO₄, Li(NiCoMn)O₂, a conductive material, and a binder. The first electrode 10 may be referred to as a negative electrode, and the second electrode 20 may be referred to as a positive electrode.

The separator 30 may be a porous substrate or may be a porous substrate with a coating layer on at least one side thereof. The porous substrate may include at least one of polyethylene, polypropylene, polyethylene terephthalate, polypropylene terephthalate, polybutylene terephthalate, polyester, polycarbonate, and polyimide. The coating layer may include a binder, and the binder may include a (polyvinylidene fluoride)-based compound. The separator 30 insulates the first electrode 10 and the second electrode 20 from each other while allowing for movement of lithium ions therebetween.

The first uncoated region 13 may be bent toward the wound center (e.g., a winding center) of the electrode assembly 120 and may overlap the first uncoated region 13 positioned relatively inside. The second uncoated region 23 may also be bent toward the wound center of the electrode assembly 120 and may overlap the second uncoated region 23 positioned relatively inside. Incision lines may be formed in (e.g., are positioned in) each of the first and second uncoated regions 13 and 23 to facilitate the bending of the first and second uncoated regions 13 and 23. The electrode assembly 120 may be accommodated in the inner space of the can 130 together with the electrolyte solution.

The can 130 may have a shape in which one side (e.g., the upper side) is open so that the electrode assembly 120 may be inserted therein. The can 130 may have a bottom portion 131 and a side portion 132 connected to (e.g., extending from) the edge of the bottom portion 131. The bottom portion 131 may be referred to as a top portion when the top and bottom of the rechargeable battery 100 are exchanged (e.g., when the rechargeable battery 100 is flipped or rotated). The can 130 may include (or may be made of) steel, stainless steel, aluminum, or an aluminum alloy, and may be formed by deep drawing.

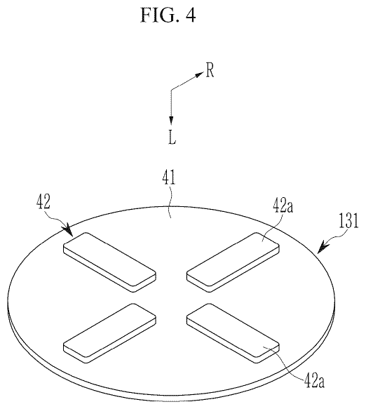

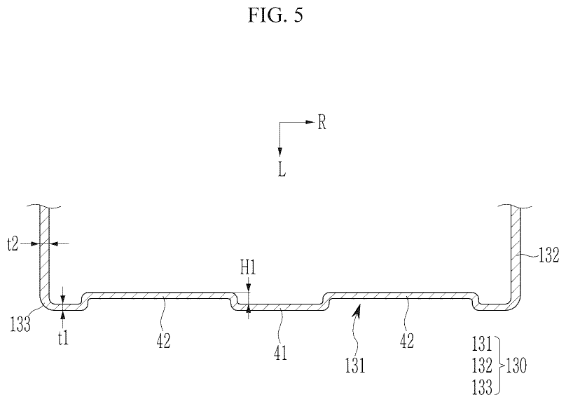

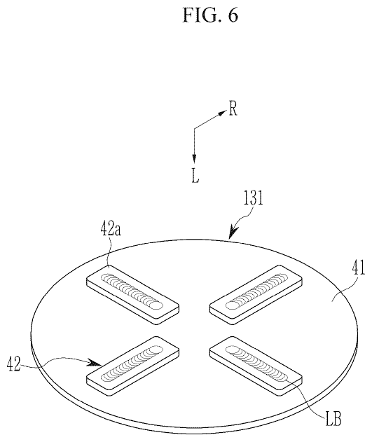

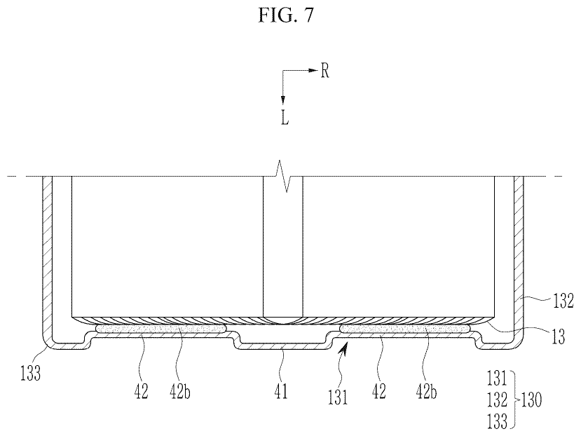

FIG. 4 is a perspective view of a bottom portion of the rechargeable battery shown in FIG. 1. FIG. 5 is a cross-sectional view of the bottom portion shown in FIG. 4. FIG. 6 is a schematic diagram showing a movement trajectory of a laser beam for welding the bottom portion shown in FIG. 4. FIG. 7 is a partial enlarged view of the rechargeable battery shown in FIG. 2.

Referring to FIG. 4 to FIG. 7, the bottom portion 131 may have a smaller thickness than that of the side portion 132 and may act as a current collecting plate by being fixed to (e.g., being directly connected to) the uncoated region of the electrode assembly 120 by welding. The bottom portion 131 may be affixed to the first uncoated region 13 and may act as a negative electrode current collecting plate. The can 130 may have (e.g., may be charged with) the same polarity as the first electrode 10 and may act as a first terminal (e.g., a negative terminal).

The can 130 may maintain mechanical strength above a certain level suitable for use as a rechargeable battery due to the relatively large thickness of the side portion 132 while enabling welding with the first uncoated region 13 due to the relatively small thickness of the bottom portion 131.

The bottom portion 131 and the side portion 132 may be integrally connected by a curved portion 133 having a thickness that changes gradually. The cross-section of the curved portion 133 may be a circular arc, for example, a circular arc shape corresponding to ¼ of a circle. The thickness of the curved portion 133 may gradually decrease from one (e.g., the upper) end in contact with the side portion 132 toward the inner end in contact with the bottom portion 131.

The bottom portion 131 may include a flat base part 41 in contact with the curved portion 133 and a plurality of welding stepped parts 42 protruding from the base part 41 toward the electrode assembly 120. The bottom portion 131 may have a certain thickness, and the base part 41 may be positioned at the same height as (e.g., on the same plane as) the inner end of the curved portion 133. The protrusions and depressions structure of the base part 41 and the plurality of welding stepped parts 42 may increase the mechanical strength of the bottom portion 131.

The bottom portion 131 may be formed to have the plurality of welding stepped parts 42 during a deep drawing process to form the can 130 or may be formed to have the plurality of welding stepped parts 42 through a separate press process.

Each of the plurality of welding stepped parts 42 may have a flat welding surface 42a, and the first uncoated region 13 of the electrode assembly 120 may be positioned in contact with the plurality of welding surfaces 42a on the inside of the can 130. The first uncoated region 13 and the plurality of welding stepped part 42 may be affixed integrally by laser welding. The laser beam for the welding may be irradiated from the outside (e.g., the lower side) of the bottom portion 131, and a welding nugget (e.g., a welding bead) 42b, which is a result of the welding, exists in the first uncoated region 13 and the welding stepped part 42.

The plurality of welding stepped parts 42 may be arranged in a pattern on the bottom portion 131 to ensure an overall uniform contact area with the first uncoated region 13. For example, each of the plurality of welding stepped parts 42 may have a rectangular bar shape and may be positioned parallel to the radius direction (e.g., a radial direction or a direction R) of the bottom portion 131. The plurality of welding stepped parts 42 may be positioned at a distance from each other in the circumferential direction of the bottom portion 131.

For example, four welding stepped parts 42 having the same size and protruding height may be positioned on the bottom portion 131, and four welding stepped parts 42 may be arranged approximately in a cross shape. Four welding stepped parts 42 may be positioned at equal distances from the center of the bottom portion 131. A laser beam LB for welding may weld the first uncoated region 13 and the welding stepped part 42 while moving in a straight line along the length direction of the welding stepped part 42.

The arrangement of the welding stepped part 42 described above ensures that the first uncoated region 13 and the welding area of the bottom portion 131 are uniform along the radius direction (e.g., the direction R) and the circumferential direction of the bottom portion 131. In addition, in the arrangement of the welding stepped part 42 described above, even if welding defects occur in one welding stepped part, the welding quality may be secured by the other, neighboring welding stepped parts, so current collecting performance may be maintained.

The thickness of the bottom portion 131 (t1, see, e.g., FIG. 5) may be approximately 0.6 times or more to less than approximately 1 times the thickness of the side portion 132 (t2). If the thickness t1 of the bottom portion 131 is less than about 0.6 times the thickness t2 of the side portion 132, the strength of the bottom portion 131 may be deteriorated or may be insufficient, causing the bottom portion 131 to be deformed outwardly (e.g., toward the lower side). If the thickness t1 of the bottom portion 131 is more than about 1 times the side portion 132 thickness t2, welding defects may occur. For example, when the thickness t2 of the side portion 132 is about 0.5 mm, the thickness t1 of the bottom portion 131 may be in a range of about 0.3 mm and about 0.5 mm.

In the bottom portion 131, a height difference between the base part 41 and the plurality of welding stepped parts 42 (H1, see, e.g., FIG. 5) may be equal to or greater than the thickness t1 of the bottom portion 131. If the height difference H1 between the base part 41 and the welding stepped part 42 is less than the thickness t1 of the bottom portion 131, it may be difficult to distinguish between the base part 41 and the welding stepped part 42, and the strength of the bottom portion 131 may be deteriorated due to a lack of the protrusions and depressions formed by the base part 41 and the welding stepped part 42.

Referring to FIG. 2, the cap plate 140 may be combined with (e.g., coupled to) the side portion 132 to seal the can 130. The cap plate 140 may be directly bonded to the side portion 132 by a method such as welding and may have (e.g., may be charged with) the same polarity as the can 130. In other embodiments, the cap plate 140 may be coupled to the side portion 132 via an insulator to maintain an insulated state from the can 130.

The rechargeable battery 100 may include a current collecting plate 150 affixed to the second uncoated region 23 of the electrode assembly 120 and a rivet terminal 160 coupled to the current collecting plate 150. The current collecting plate 150 may be positioned on the outside (e.g., the upper side) of the second uncoated region 23 and may be affixed to the second uncoated region 23 by methods such as welding. A terminal hole (e.g., a terminal opening) may be formed in (or positioned in) the center of the cap plate 140, and a rivet terminal 160 may be installed in the terminal hole with a first insulator 171. The first insulator 171 insulates the cap plate 140 from the rivet terminal 160 and seals the terminal hole to prevent leakage of the electrolyte solution therethrough.

The rivet terminal 160 may have (e.g., may be charged to) the same polarity as the second electrode 20 by combining with the current collecting plate 150 and may act as a second terminal (e.g., a positive terminal). A second insulator 172 may be arranged between the cap plate 140 and the current collecting plate 150 to insulate the cap plate 140 and the current collecting plate 150 from each other.

Referring to FIG. 1 to FIG. 7, the bottom portion 131 of the can 130 seals the electrode assembly 120 together with the side portion 132 and also acts as the current collecting plate of the first electrode 10. A conventional rechargeable battery has a negative electrode current collecting plate affixed to the first uncoated region, and the negative electrode current collecting plate is physically and electrically connected to the can in contact with the inner surface of the side portion. In the rechargeable battery 100 according to embodiments of the present disclosure, the first uncoated region 13 is directly affixed by welding to the welding stepped part 42 of the bottom portion 131.

When the rechargeable battery 100 according to embodiments of the present disclosure has the same diameter, height, and internal volume as a conventional rechargeable battery, the capacity may be relatively increased by replacing the space conventionally occupied by the negative electrode current collecting plate with the electrode assembly 120. For example, the electrode assembly 120 according to embodiments of the present disclosure may have a greater length than the electrode assembly of a conventional rechargeable battery along the length direction (e.g., the direction L) of the rechargeable battery, which provides increased capacity. Additionally, the rechargeable battery 100 according to embodiments of the present disclosure may reduce the number of parts and may simplify the internal configuration and manufacturing process compared to a conventional rechargeable battery.

The above has described in connection with an embodiment in which the can 130 is the negative terminal and the rivet terminal 160 is the positive terminal, but the opposite case is also possible. For example, the positions of the first uncoated region 13 and the second uncoated region 23 are opposite to each other, such that the first uncoated region 13 may be affixed to the current collecting plate 150 and the second uncoated region 23 may be affixed to the welding stepped part 42 of the bottom portion 131. In such an embodiment, the rivet terminal 160 may act as the negative terminal, and the can 130 may act as the positive terminal.

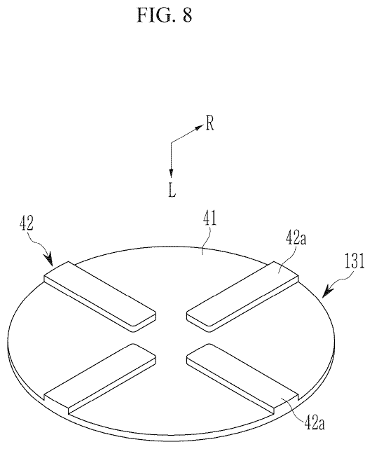

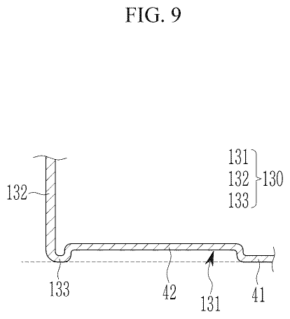

FIG. 8 is a perspective view of a bottom portion of a rechargeable battery according to another embodiment. FIG. 9 is a partial cross-sectional view of the bottom portion shown in FIG. 8. The rechargeable battery according to the illustrated embodiment has the same or similar configuration as the above-described embodiment except for the below description.

Referring to FIG. 8 and FIG. 9, in the rechargeable battery according to the illustrated embodiment, each of the plurality of welding stepped parts 42 may be positioned in contact with (e.g., may extend to) the curved portion 133. The curved portion 133 may have a semicircular or U-shaped cross-section in the region adjacent to the plurality of welding stepped parts 42, and in the region adjacent to the base part 41, the curved portion 133 may have a cross-section in the shape of the circular arc (approximately a circular arc corresponding to ¼ of the circle) as shown in, for example, FIG. 5. In the illustrated embodiment, the length of each of the plurality of welding stepped parts 42 may be extended compared to the above-described embodiment to enlarge the welding area with the first uncoated region 13.

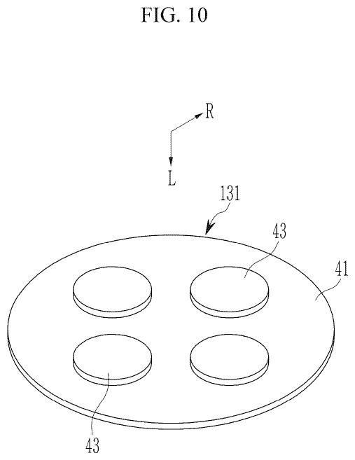

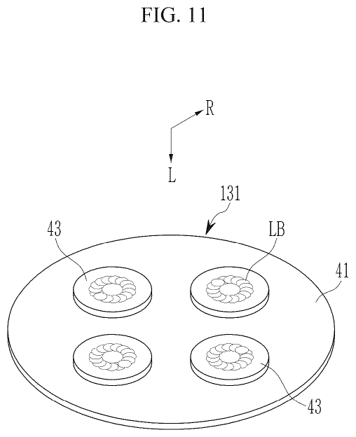

FIG. 10 is a perspective view of a bottom portion of a rechargeable battery according to another embodiment. FIG. 11 is a schematic diagram showing a movement trajectory of a laser beam for welding the bottom portion shown in FIG. 10. The rechargeable battery according to the illustrated embodiment has the same or similar configuration as the above-described embodiments except for the below description.

Referring to FIG. 10 and FIG. 11, in the rechargeable battery according to the illustrated embodiment, each of the plurality of welding stepped parts 43 may be circular (e.g., may have a circular shape) and may be positioned at a distance from each other along the circumferential direction of the bottom portion 131. The plurality of welding stepped parts 43 may have the same diameter and may be positioned at the same distance from the center point of the bottom portion 131.

For example, four welding stepped parts 43 having the same diameter and protruding height may be positioned on the bottom portion 131, and four welding stepped parts 43 may be arranged at an equal interval along the circumferential direction. The laser beam LB for the welding may weld the first uncoated region 13 and the welding stepped part 43 while moving circularly along the circumferential direction of each of the welding stepped parts 43.

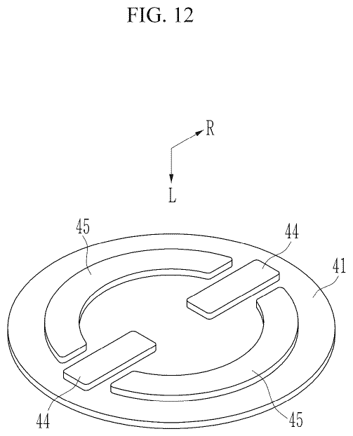

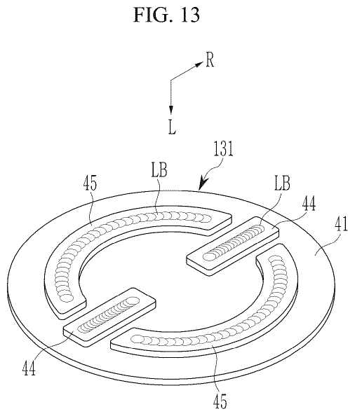

FIG. 12 is a perspective view of a bottom portion of a rechargeable battery according to another embodiment. FIG. 13 is a schematic diagram showing a movement trajectory of a laser beam for welding the bottom portion shown in FIG. 12. The rechargeable battery according to the illustrated embodiment has the same or similar configuration as the above-described embodiments except for the description below.

Referring to FIG. 12 and FIG. 13, a plurality of welding stepped parts 44 and 45 in the illustrated embodiment may be provided having at least two different shapes. For example, the plurality of welding stepped parts 44 and 45 may include a plurality of first stepped parts 44, which have a rectangular bar shape, and a plurality of second stepped parts 45, which have a circular arc shape.

Each of the plurality of first stepped parts 44 may have a rectangular bar shape and may be positioned parallel to the radius direction (e.g., the R direction) of the bottom portion 131. For example, two first stepped parts 44 having the same size and protruding height may be positioned along a straight line with the center point of the bottom portion 131 therebetween. The plurality of first stepped part 44 may be positioned away from (e.g., may be spaced apart from) the curved portion (133, see, e.g., FIG. 5) with the base part 41 in between or may be positioned in contact with the curved portion (133).

Each of the plurality of second stepped parts 45 may have a circular arc shape and may be positioned parallel to the circumferential direction of the bottom portion 131. For example, two second stepped parts 45, which have the same size, curvature, and protruding height, may be positioned so that they are symmetrical to each other with two first stepped parts 44 therebetween. The two second stepped parts 45 may be positioned at the same distance from the center point of the bottom portion 131.

The laser beam LB for welding may weld the first uncoated region 13 and the first stepped part 44 while moving in a straight line along the length direction of the first stepped part 44 and may weld the first uncoated region 13 and second stepped part 45 while moving in a curved line along the length direction of the second stepped part 45 (e.g., the circumference direction of the bottom portion 131).

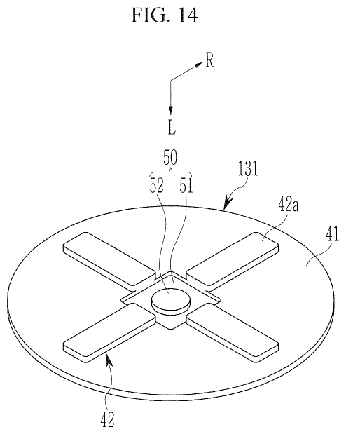

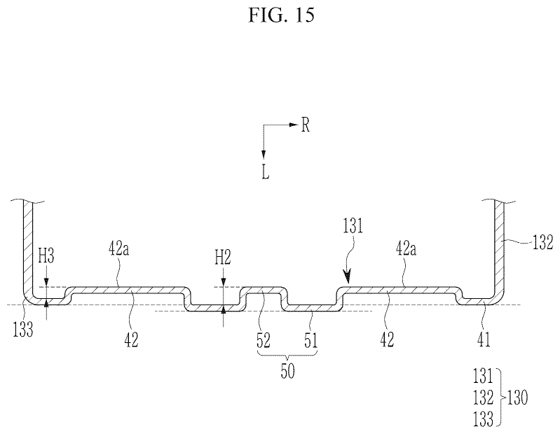

FIG. 14 is a perspective view of a bottom portion of a rechargeable battery according to another embodiment. FIG. 15 is a cross-sectional view of the bottom portion shown in FIG. 14. The rechargeable battery according to the illustrated embodiment has the same or similar configuration as the above-described embodiments except for the description below.

Referring to FIG. 14 and FIG. 15, in the rechargeable battery according to the illustrated embodiment, the bottom portion 131 may have a protrusion and depression structure 50 for load dispersion. The protrusion and depression structure 50 may be at (e.g., may extend from or may surround) the center of the bottom portion 131, and the plurality of welding stepped parts 42 may be positioned at the outside of the protrusion and depression structure 50. In FIG. 14, the plurality of welding stepped parts 42 are shown as an example, but the plurality of welding stepped parts according to any of the above-described embodiments may be positioned outside the protrusion and depression structure 50.

The protrusion and depression structure 50 may include a recess portion 51 and a protruding portion 52 protruding from the recess portion 51 toward the inside of the can 130. The protruding portion 52 may be positioned at the center of the bottom portion 131, and the recess portion 51 may be positioned to surround (e.g., to extend around a periphery of) the protruding portion 52. In FIG. 14, the circular protruding portion 52 and the quadrangle recess portion 51 are shown as examples, but the shapes of the recess portion 51 and the protruding portion 52 are not limited to the illustrated example.

The height difference H2 between the recess portion 51 and the protruding portion 52 may be greater than a height difference H3 between the base part 41 and the welding stepped part 42. For example, referring to FIG. 15, the lower surface of the recess portion 51 may be positioned approximately 0.1 mm lower than the lower surface of the base part 41 and the lower end of the side portion 132. Also, the upper surface of the protruding portion 52 may be positioned equal to or about 0.1 mm higher than the upper surface of the welding stepped part 42 (e.g., a welding surface 42a).

The protrusion and depression structure 50, which has the above-mentioned height difference, may better disperse a load applied to the bottom portion 131 by increasing the mechanical strength of the bottom portion 131, which is relatively thin compared to the side portion 132, and as a result, may suppress deformation or damage to the bottom portion 131 due to an external impact, etc.

While this disclosure has been described in connection with what is presently considered to be practical embodiments, it is to be understood that the present disclosure is not limited to the disclosed embodiments. On the contrary, the present disclosure is intended to cover various modifications and equivalent arrangements included within the spirit and scope of the appended claims and their equivalents.

What is claimed is:

1. A rechargeable battery comprising:
an electrode assembly having an uncoated region;
a can having a bottom portion facing the uncoated region and a side portion connected to an edge of the bottom portion, the can accommodating the electrode assembly in an inner space thereof, the bottom portion of the can having a base part connected to the side portion and a plurality of welding stepped parts protruding from the base part toward the uncoated region and welded to the uncoated region; and
a cap plate coupled to an open end of the side portion to seal the can.

2. The rechargeable battery of claim 1, wherein a thickness of the bottom portion is smaller than a thickness of the side portion.

3. The rechargeable battery of claim 1, wherein the bottom portion has a constant thickness, and
wherein a thickness of the bottom portion is equal to or greater than 0.6 times and less than 1 times a thickness of the side portion.

4. The rechargeable battery of claim 1, wherein the side portion and the base part are connected by a curved portion, and
wherein a height difference between the base part and each of the plurality of welding stepped parts is equal to or greater than a thickness of the bottom portion.

5. The rechargeable battery of claim 4, wherein each of the plurality of welding stepped parts is in contact with the curved portion, and
wherein the curved portion has a U-shaped cross-section in a region adjacent to the plurality of welding stepped parts.

6. The rechargeable battery of claim 1, wherein the plurality of welding stepped parts have the same shape, size, and protruding height and are at a distance from each other along a circumferential direction of the bottom portion.

7. The rechargeable battery of claim 6, wherein each of the plurality of welding stepped parts has a rectangular bar shape, and
wherein the plurality of welding stepped parts are arranged parallel to a radial direction of the bottom portion at an equal distance from a center of the bottom portion.

8. The rechargeable battery of claim 6, wherein each of the plurality of welding stepped parts has a circular shape, and
wherein the plurality of welding stepped parts are arranged at an equal interval along the circumferential direction of the bottom portion.

9. The rechargeable battery of claim 1, wherein the plurality of welding stepped parts comprise welding stepped parts having at least two different shapes.

10. The rechargeable battery of claim 9, wherein the plurality of welding stepped parts comprise a plurality of first stepped parts having a rectangular bar shape and a plurality of second stepped parts having a circular arc shape,
wherein the plurality of first stepped parts are arranged parallel to a radial direction of the bottom portion at an equal distance from a center of the bottom portion, and
wherein the plurality of second stepped parts are arranged parallel to a circumferential direction of the bottom portion at a distance from the plurality of first stepped parts.

11. A rechargeable battery comprising:
an electrode assembly having an uncoated region;
a can having a bottom portion facing the uncoated region and a side portion connected to an edge of the bottom portion, the can accommodating the electrode assembly in an inner space thereof, the bottom portion having:
a base part connected to the side portion;
a protrusion and depression structure around a center of the base part; and
a plurality of welding stepped parts protruding from the base part toward the uncoated region and welded to the uncoated region; and
a cap plate coupled to an open end of the side portion to seal the can.

12. The rechargeable battery of claim 11, wherein a thickness of the bottom portion is smaller than a thickness of the side portion.

13. The rechargeable battery of claim 11, wherein the protrusion and depression structure comprises a recess portion and a protruding portion protruding from the recess portion toward the electrode assembly, and
wherein a height difference between the recess portion and the protruding portion is greater than a height difference between the base part and each of the plurality of welding stepped parts.

14. The rechargeable battery of claim 13, wherein a lower surface of the recess portion is lower than a lower surface of the base part and a lower end of the side portion, and
wherein an upper surface of the protruding portion is equal to or higher than an upper surface of each of the plurality of welding stepped parts.

15. The rechargeable battery of claim 11, wherein the bottom portion has a constant thickness, and
wherein a thickness of the bottom portion is equal to or greater than 0.6 times and less than 1 times a thickness of the side portion.

16. The rechargeable battery of claim 11, wherein the plurality of welding stepped parts have the same shape, size, and protruding height and are arranged at a distance from each other along a circumferential direction of the bottom portion.

17. The rechargeable battery of claim 11, wherein the plurality of welding stepped parts comprise a plurality of first stepped parts having a rectangular bar shape and a plurality of second stepped parts having a circular arc shape,
wherein the plurality of first stepped parts are arranged parallel to a radial direction of the bottom portion at an equal distance from the center of the bottom portion, and
wherein the plurality of second stepped parts are arranged parallel to a circumferential direction of the bottom portion at a distance from the plurality of first stepped parts.

18. The rechargeable battery of claim 11, wherein the cap plate has a terminal hole,
wherein a rivet terminal is installed in the terminal hole via an insulator, and a current collecting plate is arranged inside the cap plate and connected to the rivet terminal, and
wherein the uncoated region is a first uncoated region, and the electrode assembly has a second uncoated region opposite the first uncoated region and affixed to the current collecting plate.

19. The rechargeable battery of claim 18, wherein the cap plate has the same polarity as the can.
